(19) United States
(12) Patent Application Publication
(10) Pub. No.: US 2017/0356652 A1
(43) Pub. Date: Dec. 14, 2017

(54) Combustor Effusion Plate Assembly

(71) Applicant: General Electric Company, Schenectady, NY (US)

(72) Inventors: Arjun Singh, Bangalore (IN); Scott Robert Simmons, Simpsonville, SC (US); Niranjana Giriyapura Thontadharya, Bangalore (IN)

(21) Appl. No.: 15/180,531

(22) Filed: Jun. 13, 2016

(51) Int. Cl. F23R 3/00; F02C 3/04; F23R 3/28; F23R 3/14; F23R 3/50

(52) U.S. Cl. CPC F23R 3/002; F23R 3/14; F23R 3/50; F23R 3/283; F02C 3/04; F23R 2900/03042; F23R 2900/03041; F05D 2220/32; F23R 2900/00018

(57) ABSTRACT

The present application provides a combustor for a gas turbine engine. The combustor may include a number of fuel nozzles and an effusion plate assembly positioned about the fuel nozzles. The effusion plate assembly may include a cold pate, a hot plate, and a number of swirl inducing structures extending therebetween.

### TECHNICAL FIELD

The present application and the resultant patent relate generally to gas turbine engines and more particularly relate to an effusion plate assembly for a gas turbine combustor with an improved cooling flow for overall increased component lifetime and reliability.

### BACKGROUND OF THE INVENTION

The operational efficiency and the overall power output of a gas turbine engine generally increases as the temperature of the hot combustion gas stream increases. Higher combustion gas stream temperatures, however, may produce higher levels of nitrogen oxides (“NOx”) and other types or regulated emissions. A balancing act thus exists between the benefits of operating the gas turbine engine in an efficient high temperature range while also ensuring that the output of nitrogen oxides and other types of regulated emissions remain below mandated levels.

Several types of known gas turbine engine designs, such as those using Dry Low NOx (“DLN”) combustors, generally premix the flow of fuel and the flow of air to reduce peak flame temperatures and, hence, overall NOx emission. DLN combustion systems utilize fuel delivery systems that typically include multi-nozzle, premixed combustors. DLN combustor designs utilize lean premixed combustion to achieve low NOx emissions without using diluents such as water or steam. Lean premixed combustion involves premixing the fuel and air upstream of the combustor flame zone and operation near the lean flammability limit of the fuel to keep peak flame temperatures and NOx production low.

Even with reduced peak flame temperatures, the components along the hot gas path of the combustor face high temperatures and otherwise overall harsh operating conditions. For example, combustor effusion plates used about a combustion chamber often sustain damage such as cracks or fractures over time due to the combustion conditions. Specifically, thermal gradients and vibrations due to combustion tones and the like may promote such effusion plate cracks or other types of damage. The time and costs involved in repairing these effusion plates may be significant.

### SUMMARY OF THE INVENTION

The present application and the resultant patent thus provide a combustor for a gas turbine engine. The combustor may include a number of fuel nozzles and an effusion plate assembly positioned about the fuel nozzles. The effusion plate assembly may include a cold pate, a hot plate, and a number of swirl inducing structures extending therebetween.

The present application and the resultant patent further provide a method of manufacturing an effusion plate assembly. The method may include the steps of forming a cold plate with a number of cold plate cooling air holes and forming a hot plate with a number of swirl inducing structures extending towards the cold plate cooling air holes and a number of effusion holes. The forming steps may use an additive manufacturing process. The step of forming a number of effusion holes may include forming a number of elliptical effusion holes.

The present application and the resultant patent further provide a combustor for a gas turbine engine. The combustor may include a number of fuel nozzles and an effusion plate assembly positioned about the fuel nozzles. The effusion plate assembly may include a cold pate, a hot plate with a number of hot plate effusion holes, and a number of fins extending therebetween.

These and other features and improvements of the present application and the resultant patent will become apparent to one of ordinary skill in the art upon review of the following detailed description when taken in conjunction with the several drawings and the appended claims.

### BRIEF DESCRIPTION OF THE DRAWINGS

FIG. 1 is a schematic diagram of a gas turbine engine showing a compressor, a combustor, a turbine, and a load.

FIG. 2 is a schematic diagram of a known combustor with an effusion plate.

FIG. 3 is a plan view of the effusion plate of FIG. 2.

FIG. 4 is a partial perspective view of a combustor with a fuel nozzle and an effusion plate assembly as may be described herein.

FIG. 5 is a perspective view of a quadrant of the effusion plate assembly of FIG. 4.

FIG. 6 is a top plan view of a cold plate of the effusion plate assembly of FIG. 4.

FIG. 7 is a top plan view of a hot plate of the effusion plate assembly of FIG. 4.

FIG. 8 is a partial cross-sectional view of the effusion plate assembly of

FIG. 4.

FIG. 9 is a schematic diagram of an effusion hole that may be used with the effusion plate assembly.

FIG. 10 is a schematic diagram of an effusion hole that may be used with the effusion plate assembly.

FIG. 11 is a partial perspective view of an effusion plate assembly as may be described herein.

FIG. 12 is a further partial perspective view of the effusion plate assembly of FIG. 11.

FIG. 13 is a partial plan view of a hot plate of the effusion plate assembly of FIG. 11.

FIG. 14 is a partial plan view of the hot plate of the effusion plate assembly of FIG. 11.

FIG. 15 is a partial perspective view of an effusion plate assembly as may be described herein.

FIG. 16 is a sectional view of a hot plate fin of the effusion plate assembly of FIG. 15.

FIG. 17 is a plan view of a hot plate fin of the effusion plate assembly of FIG. 15.

### DETAILED DESCRIPTION

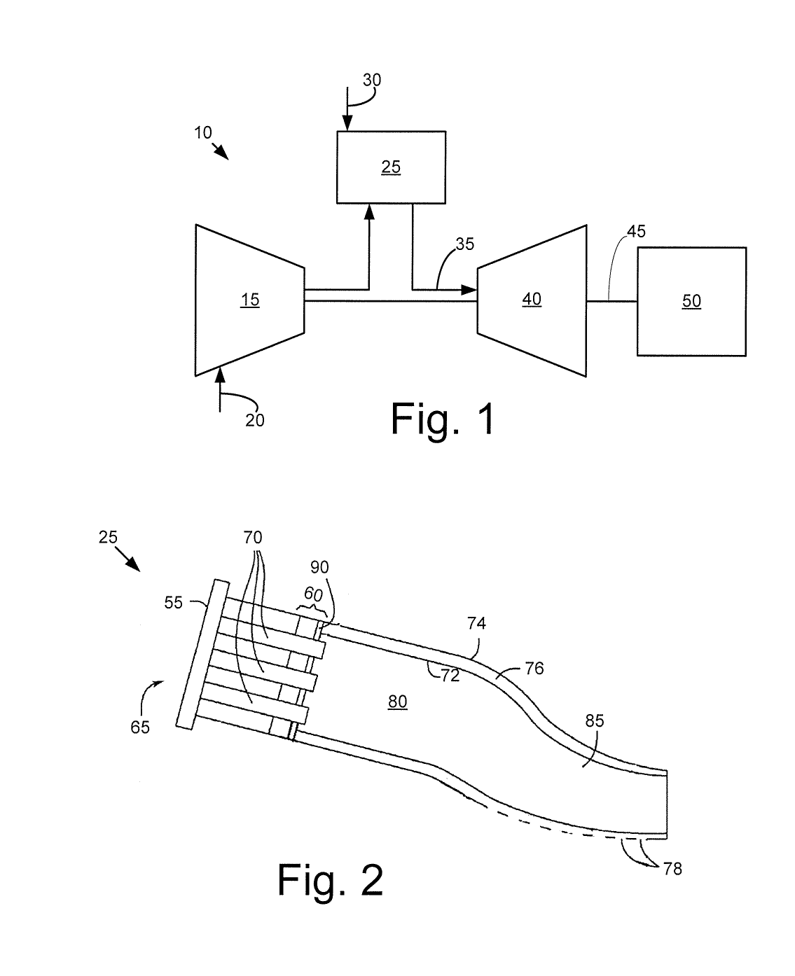

Referring now to the drawings, in which like numerals refer to like elements throughout the several views, FIG. 1 shows a schematic view of gas turbine engine 10 as may be used herein. The gas turbine engine 10 may include a compressor 15. The compressor 15 compresses an incoming flow of air 20. The compressor 15 delivers the compressed flow of air 20 to a combustor 25. The combustor 25 mixes the compressed flow of air 20 with a pressurized flow of fuel 30 and ignites the mixture to create a flow of combustion gases 35. Although only a single combustor 25 is shown, the gas turbine engine 10 may include any number of the combustors 25 arranged in a circumferential array or otherwise. The flow of combustion gases 35 is delivered in turn to a turbine 40. The flow of combustion gases 35 drives the turbine 40 so as to produce mechanical work. The mechanical work produced in the turbine 40 drives the compressor 15 via a shaft 45 and an external load 50 such as an electrical generator and the like.

The gas turbine engine 10 may use natural gas, liquid fuels, various types of syngas, and/or other types of fuels and blends thereof. The gas turbine engine 10 may be any one of a number of different gas turbine engines offered by General Electric Company of Schenectady, N.Y., including, but not limited to, those such as a 7 or a 9 series heavy duty gas turbine engine and the like. The gas turbine engine 10 may have different configurations and may use other types of components. Other types of gas turbine engines also may be used herein. Multiple gas turbine engines, other types of turbines, and other types of power generation equipment also may be used herein together.

FIG. 2 shows an example of the combustor 25 that may be used with the gas turbine engine 10 and the like. Generally described, the combustor 25 may include an end cover 55 and a combustor cap assembly 60 at an upstream or a head end 65 thereof. The end cover 55 and the combustor cap assembly 60 may at least partially support a number of fuel nozzles 70 therein. Any number or type of the fuel nozzles 70 may be used herein.

The combustor 25 may include a combustor liner 72 disposed within a flow sleeve 74. The arrangement of the liner 72 and the flow sleeve 74 may be substantially concentric so as to define an annular flow path 76 therebetween. The flow sleeve 74 may include a number of flow sleeve inlets 78 extending therethrough. The flow sleeve inlet 78 may provide a pathway for at least a portion of the flow of air 20 from the compressor 15 or elsewhere. The combustor liner 72 may define a combustion chamber 80 for the combustion of the flow of air 20 and the flow of fuel 30 downstream of the fuel nozzles 70. The aft end of the combustor may include a transition piece 85. The transition piece 85 may be positioned adjacent to the turbine 40 so as to direct the flow of combustion gases 35 thereto.

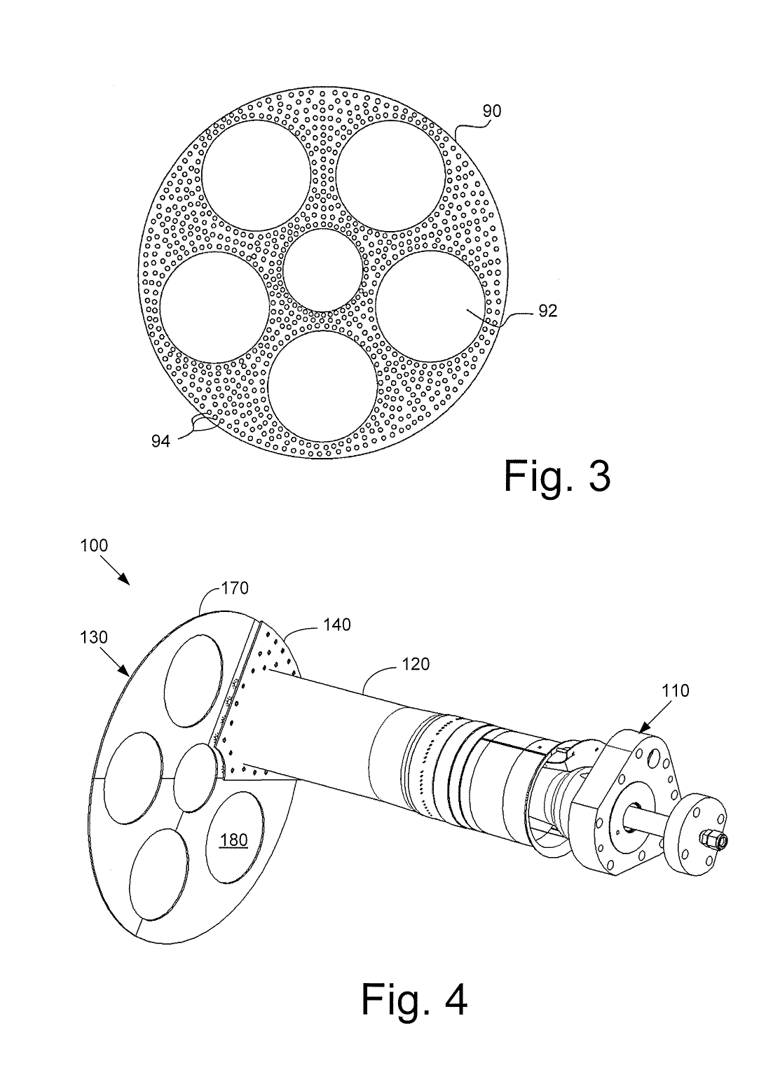

As is shown in FIG. 3, the combustor cap assembly 60 may include an effusion plate 90. The effusion plate 90 may be positioned at an upstream end of the combustion chamber 80 and about a downstream end of the fuel nozzles 70. The effusion plate 90 may be substantially circular in shape. The effusion plate 90 may include a number of fuel nozzle ports 92 for the fuel nozzles 70 to extend therethrough. Any number of the fuel nozzle ports 92 may be used herein. The effusion plate 90 also may include a number of effusion cooling holes 94. Any number of the effusion cooling holes 94 may be used herein in any suitable size, shape, or configuration. The effusion cooling holes 94 allow for effusion cooling during the combustion of the fuel and air in the adjacent combustion chamber 80. The effusion plate 90 thus may function as a radiation shield for the combustor cap assembly 60. The combustor 25 and the combustor components described herein are for the purpose of example only. Many other types of combustors and combustor components may be known.

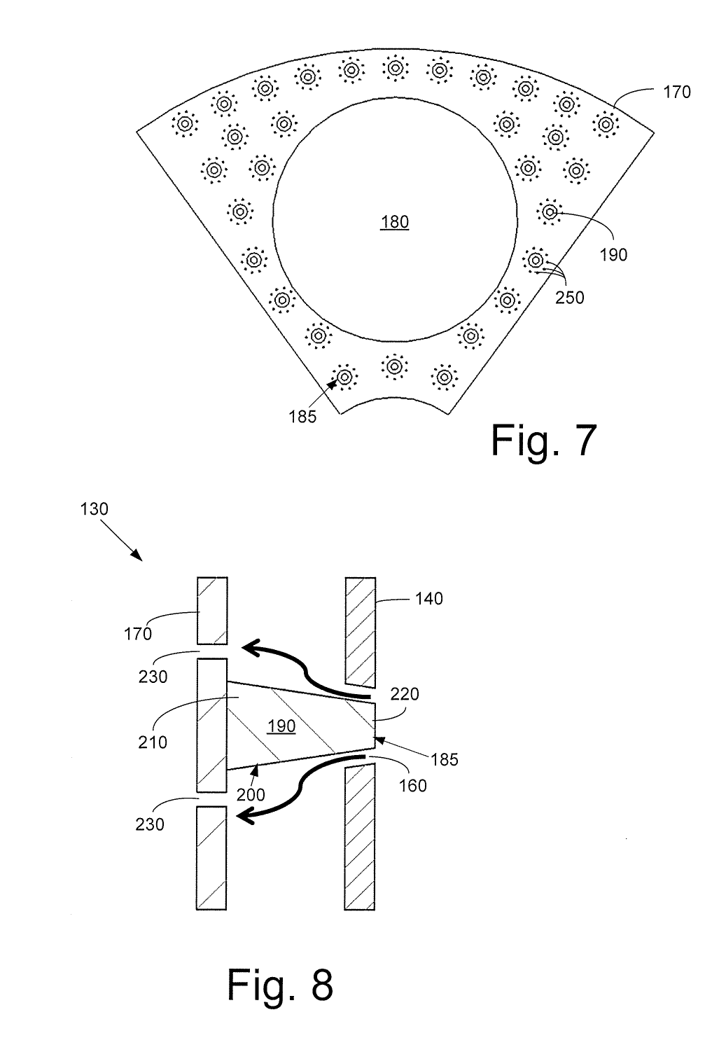

FIGS. 4-8 show examples of a portion of a combustor 100 as may be described herein. Specifically, portions of a combustor cap assembly 110 are shown. The combustor cap assembly 110 may include a number of fuel nozzles 120. Any number and type of the fuel nozzles 120 may be used herein in any suitable size, shape, or configuration.

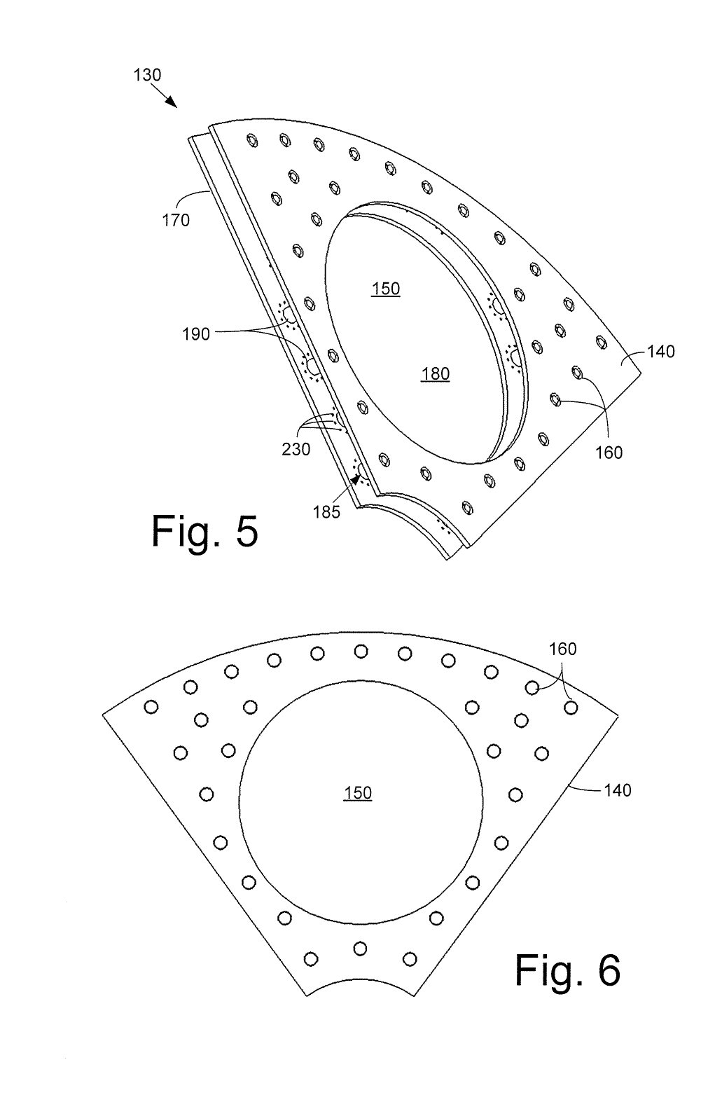

The combustor cap assembly 110 also may include an effusion plate assembly 130. Specifically, quadrants of the effusion plate assembly 130 are shown in FIGS. 5-7. The effusion plate assembly 130 may include a cold plate 140 positioned at an upstream or a cold end thereof. The cold plate 140 may include a number of cold plate fuel nozzle ports 150 extending therethrough. Any number of the cold plate fuel nozzle ports 150 may be used herein in any suitable size, shape, or configuration. The cold plate 140 also may include a number of cold plate cooling air holes 160 extending therethrough. Any number of the cold plate cooling air holes 160 may be used herein in any suitable size, shape, or configuration.

The effusion plate assembly 130 also may include an effusion plate or a hot plate 170. The hot plate 170 may be positioned downstream of and spaced apart from the cold plate 140 at a downstream or a hot end thereof facing the hot combustion gases 35. The hot plate 170 may include any number of hot plate fuel nozzle ports 170 extending therethrough. Any number of the hot plate fuel nozzle ports 170 may be used herein in any suitable size, shape, or configuration.

The hot plate 170 also may include a number of swirl inducing structures 185. In this example, the swirl inducing structures 185 may include a number of hot plate fins 190. The hot plate fins 190 may have a substantial conical shape 200. Any number of the hot plate fins 190 may be used herein in any suitable size, shape, or configuration. In this example, the hot plate fins 190 may include a base 210 extending from the hot plate 170 and an apex 220 extending towards the cold plate cooling air holes 160. Other suitable shapes, sizes, and configurations may be used herein. Hot plate fins 190 of differing sizes, shapes, and configurations may be used herein together on the same hot plate 170. The hot plate 170 also may include a number of hot plate effusion holes 230 extending therethrough. Any number of the hot plate effusion holes 230 may be used herein in any suitable size, shape, or configuration. A number of the hot plate effusion holes 230 may surround each of the hot plate fins 190. Other positions also may be used herein. Other components and other configurations may be used herein.

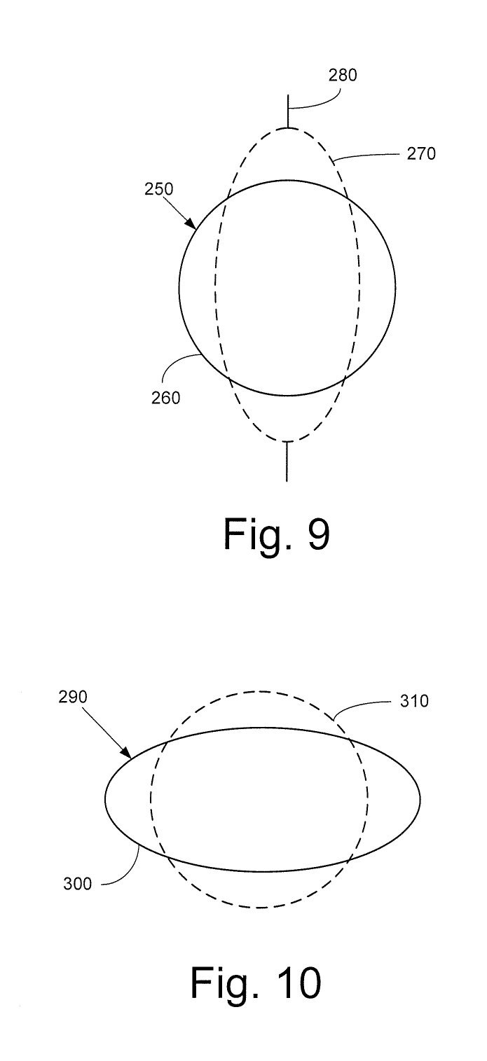

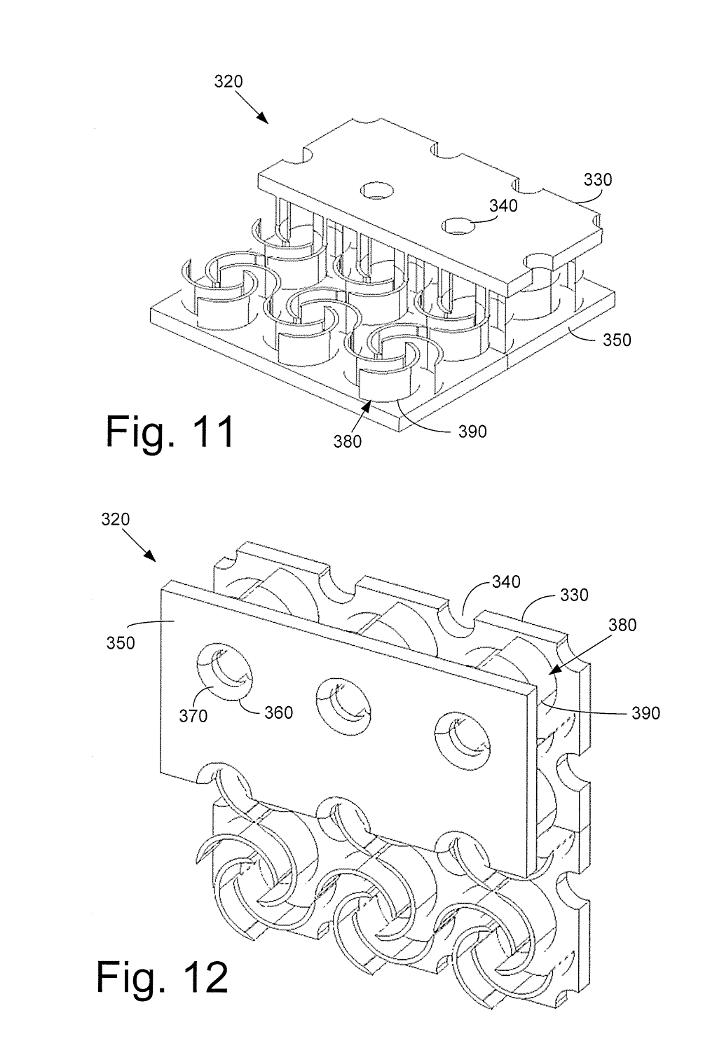

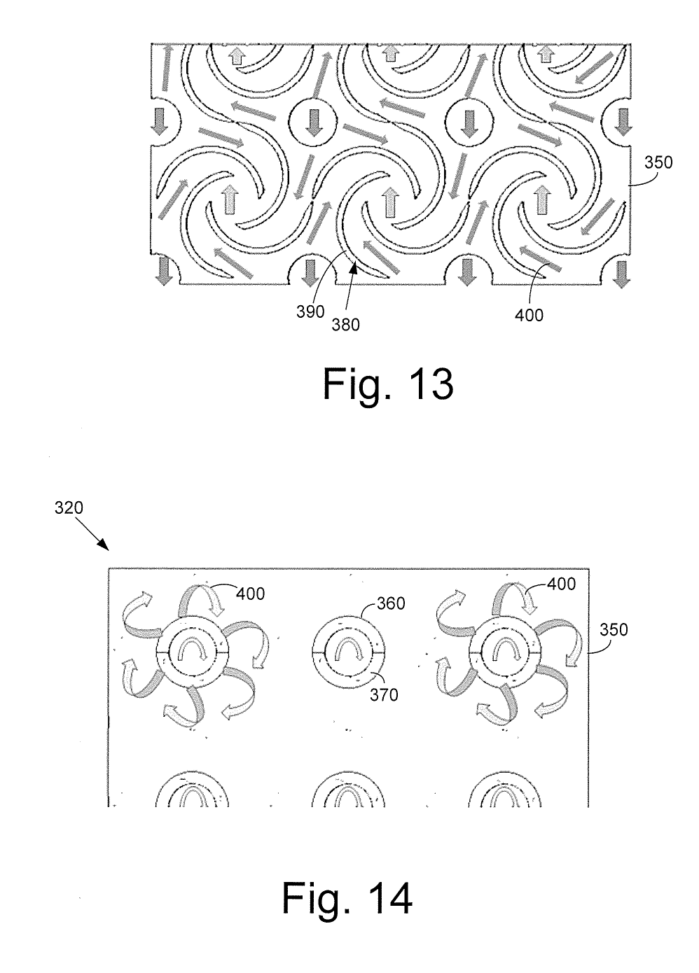

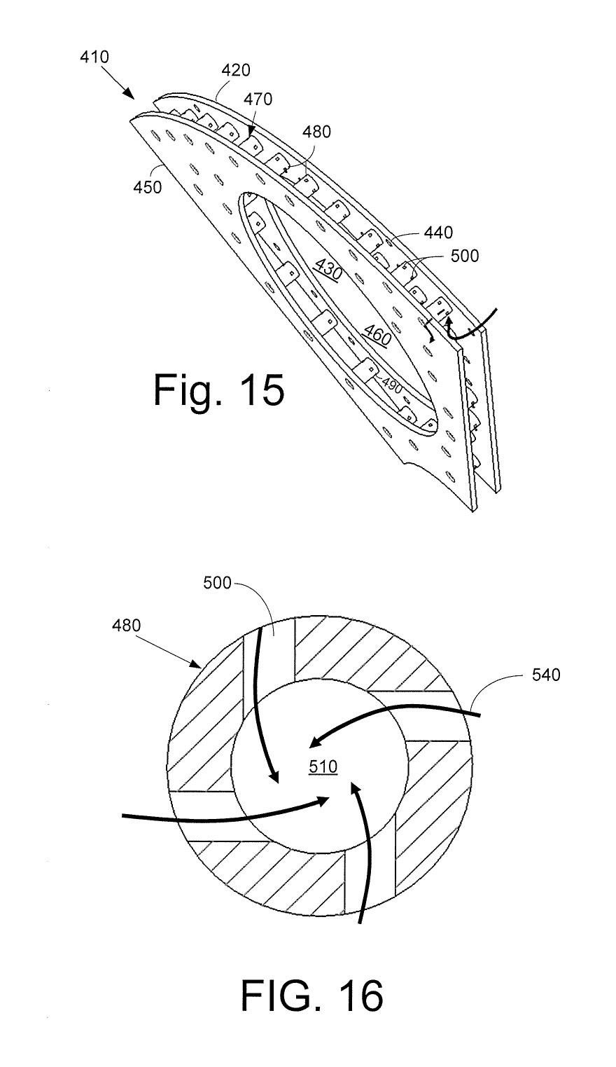

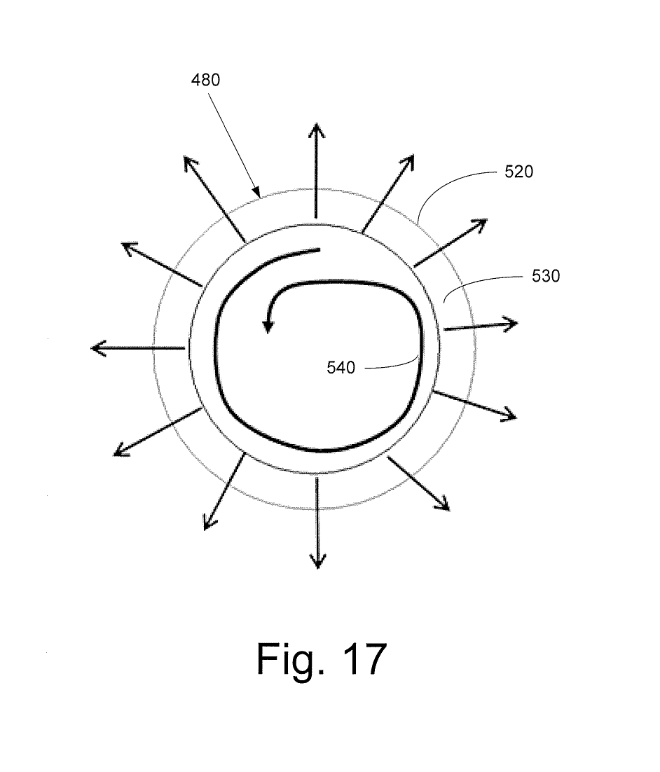

As is shown in FIG. 8, the flow of air 20 may flow towards the effusion plate assembly 130. The flow of air 20 may pass through the cold plate cooling air holes 160, swirl about the hot plate fins 190, and flow through the hot plate effusion holes 230 so as to provide effusion cooling to the hot plate 170 and the surrounding components. The use of the hot plate fins 190 increases the overall cooling surface area about the cold side end and adds structural stiffness to the overall effusion plate assembly 130. The cold plate cooling air holes 160 form a film of cooling air. Likewise, secondary flows about the hot plate fins 190 increase overall cooling effectiveness. Specifically, the hot plate fins 190 increase conduction cooling effectiveness. Increased cooling thus may provide increased overall component lifetime.

FIG. 9 shows a further embodiment of an effusion hole 250 that may be used with the effusion plate assembly 130 or otherwise. When manufactured, the effusion hole 250 generally includes a largely circular shape 260. Over time and use, however, the effusion hole 250 may deform to a substantially elliptical shape 270. This deformation to the elliptical shape 270 may promote the formation of cracks 280 and the like at the smaller radii ends thereof.

FIG. 10 thus shows a further embodiment of an effusion hole 290 as may be used herein. The effusion hole 290 may be manufactured with a substantially elliptical shape 300. Over time and use, the elliptical shape 300 may deform into a substantially circular shape 310. The circular shape 310 may resist the formation of cracks and the like given the larger and substantially uniform radii. Other components and other configurations may be used herein.

FIGS. 11-14 show a further embodiment of an effusion plate assembly 320 as may be described herein. The effusion plate assembly 320 may include a cold plate 330 at the upstream or the cold end thereof. The cold plate 330 may include any number of cold plate fuel nozzle ports (not shown). The cold plate 330 also may include a number of cold plate cooling air holes 340. Any number of the cold plate cooling air holes 340 may be used herein in any suitable size, shape, or configuration.

The effusion plate assembly 320 also may include a hot plate 350 at the downstream or the hot end thereof. The hot plate 350 may include any number of hot plate fuel nozzle ports (not shown). The hot plate 350 may include a number of hot plate effusion holes 360. Any number of the hot plate effusion holes 360 may be used herein in any suitable size, shape, or configuration. The hot plate effusion holes 360 may have a filleted shape 370 in whole or in part. Each of the hot plate effusion holes 360 may be surrounded by one or more swirl inducing structures 380. In this example, the swirl inducing structures 380 may include a number of semi-circular structures 390 positioned around and leading to the hot plate effusion holes 360. The hot plate effusion holes 360 with the filleted shape 370 and the semi-circular structures 390 may promote a swirling flow 400 passing through the hot plate effusion holes 360.

In use, cooling air 20 enters the effusion plate assembly 320 via the cold plate cooling air holes 340 of the cold plate 330. The cooling airflow thus impinges on the backside of the hot plate 350. After the cooling air impinges on the back of the hot plate 350, the air flow enters the swirl inducing structures 380 so as to cool the hot plate 350 and to develop swirl 400 therein. The cooling air develops such swirl 400 so as to create a film on the downstream side of the hot plate 350 after exiting the hot plate effusion holes 360 so as to provide improved cooling. The hot plate effusion holes 360 may have the filleted design 370 at the outlet thereof so as to further encourage the development of swirl therein. Other components and other configurations may be used herein.

The effusion plate assembly 320 and the swirl inducing structures 380 in particular, may be produced in a Direct Metal Laser Melting (“DMLM”) manufacturing process. Such a DMLM manufacturing process or other types of additive or three dimensional printing processes provide the ability to produce complicated three dimensional features herein. For example, the shape of the swirl inducing structures 380 may provide for the improved swirling flow therein. A thermal barrier coating and the like also may be applied to the hot plate 350. Any overspray extending through the hot plate effusion holes 360 thus may be applied to the cold plate 330. The hot plate effusion holes 360 are sufficiently large to allow the spray to flow therethrough without clogging. Other components and other configurations may be used herein.

FIGS. 15-17 show a further embodiment of an effusion plate assembly 410 as may be described herein. The effusion plate assembly 410 may include a cold plate 420 at the upstream or the cold end thereof. The cold plate 420 may include any number of cold plate fuel nozzle ports 430. The cold plate 420 also may include a number of cold plate cooling air holes 440. Any number of the cold plate cooling air holes 440 may be used herein in any suitable size, shape, or configuration.

The effusion plate assembly 410 also may include a hot plate 450 at the downstream or the hot end thereof. The hot plate 450 may include any number of hot plate fuel nozzle ports 460. The hot plate 450 also may include also may include a number of swirl inducing structures 470. In this example, the swirl inducing structures 470 may include a number of hot plate fins 480. The hot plate fins 480 may be offset from the cold plate cooling air holes 440. The hot plate fins 480 may have a substantially cylindrical shape 490 and may extend from the hot plate 450 to the cold plate 420. The hot plate fins 480 also may have a substantially hollow shape with one or more cooling air entry holes 500 leading to a central air passage 510 and an effusion hole 520. The effusion hole 520 may have a chamfered shape 530 on the hot side thereof. Any number of the hot plate fins 480 may be used herein in any suitable size, shape, or configuration. Other suitable shapes, sizes, and configurations may be used herein. Hot plate fins 480 of differing sizes, shapes, and configurations may be used herein together on the same hot plate 450. Other components and other configurations may be used herein.

In use, cooling air 20 enters the effusion plate assembly 410 via the cold plate cooling air holes 440 of the cold plate 420. The cooling airflow thus impinges in part on the backside of the hot plate 450 while a portion of the cooling air flow enters the hot plate fins 480 via the cooling entry holes 500, passes through the central air passage 510, and exits along the hot side of the hot plate 450 through the effusion holes 520 to provide film cooling. The positioning of the cooling entry holes 500 creates swirl 540 within the central air passage 510. The swirling air flow thus exits the effusion holes 520 so as to provide the film cooling on the hot plate 450. The chamfered shape 530 of the effusion holes 520 at the outlet thereof further encourage the development of swirl therein. Other components and other configurations may be used herein.

It should be apparent that the foregoing relates only to certain embodiments of the present application and the resultant patent. Numerous changes and modifications may be made herein by one of ordinary skill in the art without departing from the general spirit and scope of the invention as defined by the following claims and the equivalents thereof.

We claim:

1. A combustor for a gas turbine engine, comprising:
a plurality of fuel nozzles; and
an effusion plate assembly positioned about the plurality of fuel nozzles;
the effusion plate assembly comprising a cold pate, a hot plate, and a plurality of swirl inducing structures extending therebetween.

2. The combustor of claim 1, wherein the cold plate comprises a plurality of cold plate fuel nozzle ports.

3. The combustor of claim 1, wherein the cold plate comprises a plurality of cold plate cooling air holes.

4. The combustor of claim 1, wherein the hot plate comprises a plurality of hot plate fuel nozzle ports.

5. The combustor of claim 1, wherein the hot pate comprises a plurality of hot plate effusion holes.

6. The combustor of claim 5, wherein the plurality of hot plate effusion holes comprises an elliptical shape or a circular shape.

7. The combustor of claim 1, wherein the plurality of swirl inducing structures is attached to the hot plate and extends towards the cold plate.

8. The combustor of claim 1, wherein the plurality of swirl inducing structures comprises a plurality of fins.

9. The combustor of claim 8, wherein the plurality of fins comprises a conical shape.

10. The combustor of claim 8, wherein the plurality of fins comprises a base attached to the hot plate and an apex extending towards the cold plate.

11. The combustor of claim 8, wherein the hot plate comprises a plurality of effusion holes surrounding each of the plurality of fins.

12. The combustor of claim 1, wherein the plurality of swirl inducing structures comprises a plurality of semi-circular structures.

13. The combustor of claim 12, wherein the hot plate comprises thermal barrier coating thereon.

14. A method of manufacturing an effusion plate assembly, comprising:
forming a cold plate with a plurality of cold plate cooling air holes; and
forming a hot plate with a plurality of swirl inducing structures extending towards the plurality of cold plate cooling air holes and a plurality of effusion holes;
wherein the forming steps comprise an additive manufacturing process.

15. The method of claim 14, wherein the step of forming a plurality of effusion holes comprises forming a plurality of elliptical effusion holes.

16. A combustor for a gas turbine engine, comprising:
a plurality of fuel nozzles; and
an effusion plate assembly positioned about the plurality of fuel nozzles;
the effusion plate assembly comprising a cold pate, a hot plate with a plurality of hot plate effusion holes, and a plurality of fins extending therebetween.

17. The combustor of claim 16, wherein the cold plate comprises a plurality of cold plate fuel nozzle ports and a plurality of cold plate cooling air holes.

18. The combustor of claim 1, wherein the hot plate comprises a plurality of hot plate fuel nozzle ports.

19. The combustor of claim 16, wherein the plurality of fins comprises a conical shape.

20. The combustor of claim 8, wherein the plurality of effusion holes surrounds each of the plurality of fins.
